(19) United States
(12) Patent Application Publication
(10) Pub. No.: US 2004/0072616 A1
(43) Pub. Date: Apr. 15, 2004

(54) Webmaster tools' E-commerce role playing platform

(76) Inventor: Matthew Cole Harmon, Hollywood, CA (US)

Correspondence Address: WebMaster Tools Inc., 7095 Hollywood Blvd. #813, Hollywood, CA, 90028, US

(21) Appl. No.: 09/730,165

(22) Filed: Dec. 5, 2000

(51) Int. Cl. G06F 19/00

(52) U.S. Cl. 463/42

(57) ABSTRACT

The E-Commerce Role Playing Platform concept runs solely via the world wide web. A game server will be used to connect players.

WebMaster Tools, Inc. will be the sole owner and operator of the game accounts and will distribute earnings/fees accordingly.

Legally, the E-Commerce Role Playing Platform will require, upon initial entrance to the game, parental approval from players under the age of 18 yrs. old and acceptance of the terms & licensing agreements of the E-Commerce Role Playing Platform and the company that licenses it. Anticipating the appeal this format will have to younger players, the licensing company will be required to conduct random checks via phone, e-mail, and mail to verify age and consent. This will be a requirement of licensing the E-Commerce Role Playing Platform from WebMaster Tools, Inc..

WebMaster Tools, Inc. will also require, via the “game account” that it provides the licensing company, a safety net for maximum amount of loss in a given time period, based on skill level, game level, & amount of funds in the “game account.”

### BACKGROUND OF THIS INVENTION

The E-Commerce Role Playing Platform finds its roots in the decades old game of Dungeons & Dragons™. Based on this type of fantasy, multi-user game, WebMasterTools, Inc. proposes to take this concept to the internet and add the ability to gain revenue from this genre of game play.

### SUMMARY OF THIS INVENTION

The E-Commerce Role Playing Platform is a fairly simple computer game format that is in the context of multi-user game play via the internet. E-Commerce Role Playing Platform revolves around two very important central components: 1) a fantasy game and 2) a player's “game account.” The fantasy game will provide a forum for interactive, competitive game ploy. The “game account” will accept deposits, enable a player to make purchases for character building, allow the player to accept winnings, & pay a player's opponent upon defeat.

### DESCRIPTION OF THIS INVENTION

Object: The object of this type of game play is to begin with a fantasy computer game, along the lines of a Dungeons & Dragons™ format, using a set dollar amount to enter the initial game play. Ultimately, using additional monetary contributions to a player's “game account,” the player's goal is to beat out his opponents and win the money that is held in their “game accounts.”

Operation: The E-Commerce Role Playing Platform will be licensed to various companies who present fantasy game concepts to WebMaster Tools, Inc. for review. Once licensing is approved, the game will be designed or adjusted to fit the E-Commerce Role Playing platform, and the platform will be tailored for the specific game.

User game play actually starts with the creation of and an initial deposit of funds into a player's “game account.” There is a beginner mode, that can scale into the various levels of game play, that requires no initial deposit to the “game account” and a user can simply access his/her “game account” for the gaining of funds from opponents.

The initial deposit (via echeck, credit card, or internet dollars) will allow a player to a) activate a “game account” that will ultimately accept his/her winnings from other players and pay opponents that he/she loses against, b) choose a character, c) give his/her character a basic weapon for defense and battle, and d)the ability to buy additional lives, weapons, and added features as he/she continues in their game experience. The “game account” will be the basis of a player's entrance into the interactive, multi-user game play. The initial deposit will be made at four levels, raising in monetary value based on the skill level that a player wishes to enter the game play. For example, a $20 “game account” deposit might be required for entrance as a novice player, a $35 “game account” deposit for entrance as an experienced player, a $50 “game account” deposit for entrance as an advanced player, & a $100 “game account” deposit for entrance as an expert player. Gaining access to these levels is not limited to making these deposits, as a player can enter the game under novice status and, through successful game play, become an expert player.

Once an initial deposit has been made and a “game account” has been established, the player chooses a character that will serve as his tool to defeat his opponents throughout the levels of game play. The characters that are initially available to a user are very basic and their weaponry are extremely limited. In order for a player to progress his/her character's abilities, defense, energy, & special skills, he/she has three options:

1. A player con purchase additional lives, weapons, energy, & special skills via his/her “game account”

2. A player can beat out his opponents and take over any additional characteristics that his opponent had gained

3. A player can use the “gold” (money) from his defeated opponents' “game account” to purchase additional characteristics

A player cannot use his/her “game account” to defeat levels of game play. The “game account” is held for purchase of additional characteristics for a player's character or for paying a successful opponent. A player con utilize purchased characteristics to help defeat opponents, and, therefore, levels—thus progressing in his game; however, there is no way to directly purchase progression through levels in the game.

A player is never required to add money to his/her “game account”, after the initial deposit, if a player so chooses, since all of the advantages that are available for purchase can also be garnered from accurate and successful game ploy.

Revenue: E-Commerce Role Playing Platform creates revenue for the company that runs and maintains the game by taking a percentage of the initial deposit, purchase of additional characteristics, & any profits made through successful game play.

For example, the licensing company will take a small percentage of Player A's initial “game account” deposit for operating costs and game maintenance (as well as profit). Likewise, if Player A chooses to purchase an upgrade from basic weaponry to medium level weaponry, the licensing company will take those fees from his/her “game account” automatically. And, lastly, if Player A defeats Player B and, consequently, the gold from Player B's “game account” is transferred into his/her “game account”, the licensing company will take a small percentage of those winnings to contribute to its revenue.

Goal/winning the game: Ultimately, the level of winning that a player wishes to achieve can vary substantially based on how for and for how long a player is willing to engage in game play.

A player has a number of options for removing him/herself from the game in a successful manner.

1. A player can reach his/her desired level and choose not to continue game play, at which point, the player con opt to cash out his/her “game account”, with a small percentage of the “game account” funds returning to the licensing company.

2. A player con defeat opponents and complete a level, moving from, for instance, a novice player to an experienced player or from an experienced player to on advanced player. At this point, the player con choose to continue the game ploy in his/her newly acquired game level or he/she con opt to cash out his/her “game account”, with a small percentage returning to the licensing company.

3. A player con succeed in all levels of game play, defeating the highest ranked player at the expert level, at which point he/she can opt to become a “game master” and keep the funds in his/her “game account” intact. Or the player may defeat the highest ranked player at the expert level and choose to move onto the professional level that moves all of a player's “game account” funds into a “professional game account.” This account is held in trust as a player maneuvers through the professional competition that will be completed in cycles of six months. Should a player be the ultimate winner of a six month cycle of professional level game play, he/she will receive all of the winnings from his/her opponents' “professional game accounts,” and, also, the licensing company will be responsible to add a 25% contribution to those winnings as a bonus for being an ultimate professional player in a six month cycle. It is only possible for a player to win the six month professional cycle once every 2 cycles. Should a licensing company agree to continue with the process, they have the option to hold yearly competitions between the two winners of the six month cycles for a monetary sum/prize determined by the licensing company.

When a player is offline, he/she has two options for his/her character. A character will have the ability to “camp” free of charge with minimal safety, but the possibility of the character being attacked by on opponent is in existence. For a minimal fee, a character con be camped on a daily basis with maximum protection and there is no possibility for attack by opponents, while offline. There will also be an “emergency camp” button for quick shut down of game Play

Advantages: The E-Commerce Role Playing Platform will be applicable to any number of already designed fantasy games and any new fantasy games that will be developed specifically for the E-Commerce Role Playing Platform. It will appeal to all ages that wish to engage in continued, interactive, progressive fantasy game play. The concept that fuels the E-Commerce Role Playing platform is designed to compliment intelligent game playing, foster creative/imaginative virtual experience, & encourage interactive, non-aggressive competition between players from around the world.

### Conclusion, Ramifications, & Scope

The E-Commerce Role Playing Platform provides a forum of game playing that has yet to be broached by the video game or Internet industries. Not only will this format of game play appeal to players of all ages, races, & sexes, it will single-handedly provide a forum for interactive, non-aggressive game play for members of the world wide web community. The platform has the potential for wide-scale distribution to numerous companies with the ability to give the public new material in a highly competitive genre. This format can be used to propagate imagination, encourage intelligent spending habits via player maintenance of the “game account,” & generate revenue for companies while simultaneously contributing to the positive connection of people around the world. The market for the E-Commerce Role Playing Platform is universal and can be translated into any number of languages for the entertainment and the development of non-aggressive competition in other countries.

1. A platform for game play within existing games or games developed around the e-commerce role playing platform:
(a) providing interactive, multi-user game play via the internet that will generate revenue for a variety of already established & yet to be developed game companies focusing on this particular game platform
(b) providing a character input that requires imagination, intelligence, & skill from the user and his/her opponent and promoting a forum for non-aggressive competition between players of all ages
(c) storing a history of events, game play tactics, opponents defeated, & “game account” transactions for continued game play and learning through prior mistakes via the “game account”, which is customized to suit each licensing company &, subsequently, each player who establishes an account
